(19) United States
(12) Patent Application Publication
(10) Pub. No.: US 2006/0211285 A1
(43) Pub. Date: Sep. 21, 2006

(54) Socket with protecting device

(75) Inventors: Ching-Wen Cheng, Taoyuan Hsien (TW); Chien-Hua Chiao, Taoyuan Hsien (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Delta Electronics, Inc.

(21) Appl. No.: 11/321,204

(22) Filed: Dec. 29, 2005

(30) Foreign Application Priority Data
Mar. 15, 2005 (CN) 200520007340.3

(51) Int. Cl. H01R 13/44

(52) U.S. Cl. 439/143

(57) ABSTRACT

A socket with a protecting device is disclosed. The socket with a protecting device comprises a socket unit having a surface with plural electrode holes and a pivot hole thereon, and a protecting device disposed on the surface of the socket unit for protecting the plural electrode holes of the socket unit. The protecting device comprises plural openings corresponding to the plural electrode holes of the socket unit and a rotating portion to be plugged into the pivot hole of the socket unit. Thereby the protecting device rotates relatively to the surface of the socket unit for aligning or staggering the plural openings and the plural electrode holes to render the socket in an open or a closed status.

### FIELD OF THE INVENTION

The present invention relates to a socket, and more particularly to a socket with a protecting device.

### BACKGROUND OF THE INVENTION

Electric equipments or products are indispensable for people in daily life. Most of the electric equipments or products need electric force as power for working, therefore sockets such as wall socket, extension socket, shunting socket are set in the surroundings for the electric equipments and products. Most of the sockets are located at the lower place in order to be used conveniently. However, kids may touch the sockets and get electric shocks easily. Besides, dust or foreign matters such as water, other liquid or solid subjects are also easy to get into the electrode holes and cause the bad electric contact or short circuit.

To avoid the foreign matters getting into the electrode holes, the prior art has used a protecting device for protecting the electrode holes. Please refer to FIG. 1, which is a schematic diagram showing a conventional socket with a protecting device. As shown in FIG. 1, the conventional socket 1 has a socket unit 10 and a protecting device 11. The socket unit 10 has a surface with a depression 12, which comprises plural electrode holes 13 on the bottom surface to be plugged by the terminals of the plug. The depression 12 further comprises a leading groove 14 on the bottom surface, and projections 15 and 16 with sliding grooves 151 and 161 are disposed at two opposite sides of the depression 12, wherein the openings of the sliding grooves 151 and 161 are facing each other.

The protecting device 11 is a plate having a length d approximately equal to the length D of the depression 12, and a width w smaller than the width W of the depression 12. A leading block 17 is disposed on the bottom of the protecting device 11, and protrusions 18 and 19 are disposed at the two opposite sides of the protecting device 11. While assembling, the leading block 17 is inserted into the leading groove 14 and the protrusions 18 and 19 are inserted into the sliding grooves 151 and 161 respectively, therefore the protecting device 11 can slide within the depression 12. There are plural openings 110 on the protecting device 11 with the shape corresponding to that of the electrode holes 13 on the depression 12 of the socket unit 10. When moving the protecting device 11 within the depression 12, the leading block 17 and the protrusions 18 and 19 slide along the leading groove 14 and the sliding grooves 151 and 161 respectively, so that the plural electrode holes 13 are turned into an open or a closed status with the alignment or the stagger situation of the plural openings 110 on the protecting device 11 and the plural electrode holes 13 on the socket unit 10, so as to protect the socket 1 and avoid the foreign matters to get into the electrode holes 13.

However, the above conventional protecting device 11 is moved linearly with the protrusions 18, 19, and the block 17 sliding along the sliding grooves 151, 161, and the leading groove 14 respectively to render the socket 1 in an open or a closed status. Therefore, a space for the movement of the protecting device 11 should be preserved and thus the purpose for miniaturization cannot be achieved, and the space on the surface of the socket for printing or utilizing is also limited. In addition, the fabrication of the conventional socket with a protecting device is complex and the cost is high, hence the yield cannot be raised up.

Therefore, the purpose of the present invention is to develop a socket with a protecting device for protecting the socket and dealing with the above problems.

### SUMMARY OF THE INVENTION

An object of the present invention is to provide a socket with a protecting device for protecting the socket from dust or foreign matters getting into the socket, so as to prevent the situations of bad electric contact or short circuit.

Another object of the present invention is to provide a socket with a protecting device for preventing kids from touching the electrode holes directly to further avoid the danger of electric shock.

An additional object of the present invention is to provide a socket with a protecting device for dealing with the problem of space waste, especially when plural socket units are combined together, the space utilization is confined due to the space needs to be preserved for the movement of the protecting device.

A further object of the present invention is to provide a socket with a protecting device to overcome the defects of the prior art, such as complex structure, difficult assembling and bad yield.

According to an aspect of the present invention, the socket with a protecting device is provided. The socket with a protecting device comprises a socket unit having a surface with plural electrode holes and a pivot hole thereon, and a protecting device disposed on the surface of the socket unit for protecting the plural electrode holes of the socket unit. The protecting device comprises plural openings corresponding to the plural electrode holes of the socket unit and a rotating portion to be plugged into the pivot hole of the socket unit. Thereby the protecting device rotates relatively to the surface of the socket unit for aligning or staggering the plural openings and the plural electrode holes to render the socket in an open or a closed status.

In an embodiment, the socket unit further comprises a first positioning element and a second positioning element disposed thereon, and the protecting device further comprises a third positioning element to be engaged with the first positioning element or the second positioning element.

In an embodiment, the third positioning element is engaged with the first positioning element and thus the plural openings and the plural electrode holes are aligned to render the socket in the opening status. On the contrary, the third positioning element is engaged with the second positioning element and thus the plural openings and the plural electrode holes are staggered to render the socket in the closed status.

In an embodiment, the first positioning element and the second positioning element are positioning blocks while the third positioning element is a positioning hole. Or the first positioning element and the second positioning element are positioning holes while the third positioning element is a positioning block.

In an embodiment, the rotating portion comprises a rotating shaft, a protrusion disposed on the end of said rotating shaft, and a slit for dividing the rotating shaft and the protrusion into two parts, respectively.

According to an aspect of the present invention, a protecting device disposed on a socket is provided. The socket includes at least a socket unit having a surface with plural electrode holes and a pivot hole thereon. The protecting device comprises plural openings corresponding to the plural electrode holes of the socket unit, and a rotating portion to be plugged into the pivot hole of the socket unit. Thereby the protecting device rotates relatively to the surface of the socket unit for aligning or staggering the plural openings and the plural electrode holes to render the socket in an open or a closed status.

In an embodiment, the socket unit further comprises a first positioning element and a second positioning element disposed thereon, and the protecting device further comprises a third positioning element to be engaged with the first positioning element or the second positioning element.

In an embodiment, the third positioning element is engaged with the first positioning element and thus the plural openings and the plural electrode holes are aligned to render the socket in the opening status. On the contrary, the third positioning element is engaged with the second positioning element and thus the plural openings and the plural electrode holes are staggered to render the socket in the closed status.

In an embodiment, the first positioning element and the second positioning element are positioning blocks while the third positioning element is a positioning hole. Or the first positioning element and the second positioning element are positioning holes while the third positioning element is a positioning block.

In an embodiment, the rotating portion comprises a rotating shaft, a protrusion disposed on the end of said rotating shaft, and a slit for dividing the rotating shaft and the protrusion into two parts, respectively.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic diagram showing a conventional socket with a protecting device;

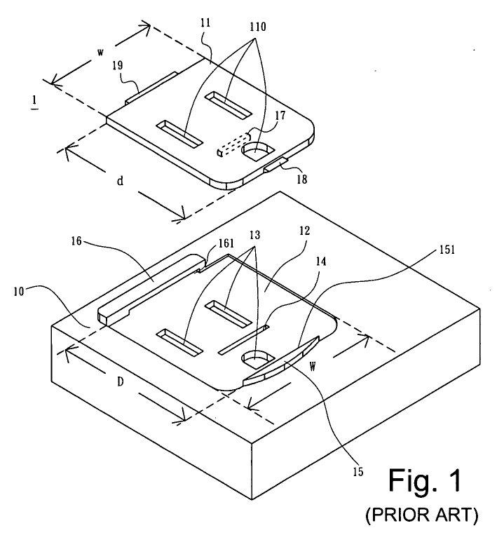

FIG. 2 is a schematic diagram showing a socket with a protecting device according to a preferred embodiment of the present invention; and

FIG. 3 is a schematic diagram showing the assembly structure of the socket unit and the protecting device in FIG. 2, wherein the electrode holes are in an open status; and

FIG. 4 is a schematic diagram showing the assembly structure of the socket unit and the protecting device in FIG. 2, wherein the electrode holes are in a closed status.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

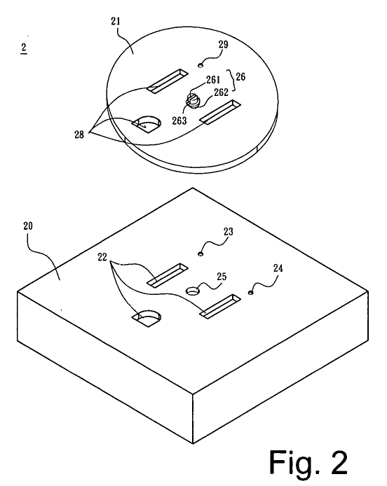

Please refer to FIG. 2, which is a schematic diagram showing a socket with a protecting device according to a preferred embodiment of the present invention. As shown in FIG. 2, the socket 2 comprises a socket unit 20 and a protecting device 21. The socket unit 20 has a surface with plural electrode holes 22 thereon, and the electrode holes 22 have predetermined size and shape to be plugged by the terminals of the plug. In addition, the surface of the socket unit 20 further comprises a first positioning element 23 and a second positioning element 24. The first positioning element 23 and the second positioning element 24 are disposed near the electrode holes 22 and are preferably positioning blocks or positioning holes. The socket unit 20 also includes a pivot hole 25 which is located on the surface among the plural electrode holes 22 and is preferably a round-shaped hole.

The protecting device 21 is disposed on the surface of the socket unit 20, in which the protecting device 21 can be protruded out of or imbedded beneath the surface of the socket unit 20. The protecting device 21 comprises a rotating portion 26 extending downward from the bottom surface of the protecting device 20 for inserting into the pivot hole 25 on the socket unit 20. Hence, the protecting device 21 can rotate relatively to the surface of the socket unit 20 with the rotating portion 26 as a shaft. Besides, the protecting device 21 has plural openings 28 with the shape, size, and position corresponding to the electrode holes 22 on the socket unit 20. The protecting device 21 further comprises a third positioning element 29 disposed on the bottom surface of the protecting device 21 and near the plural openings 28. The third positioning element 29 is preferably a positioning hole or a positioning block corresponding to the first positioning element 23 and the second positioning element 24 on the socket unit 20. The distance from the third positioning element .29 to the rotating portion 26 of the protecting device 21 is the same as that from the first positioning element 23 or the second positioning element 24 to the pivot hole 25 of the socket unit 20. Therefore, the third positioning element 29 can be engaged with the first positioning element 23 or the second positioning element 24 for fixing the protecting device 21 at the exact position. Since the protecting device 21 rotates relatively to the surface of the socket unit 20 with the rotating portion 26 as a shaft, the electrode holes 22 of the socket unit 20 can be exposed or covered, which depends on whether the openings 28 of the protecting device 21 and the electrode holes 22 of the socket unit 20 are aligned or not, so as to open the electrode holes 22 for using or close the electrode holes 22 for avoiding the dust or foreign matters getting into the electrode holes 22.

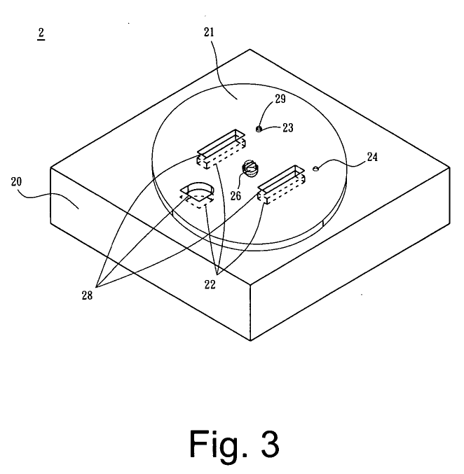

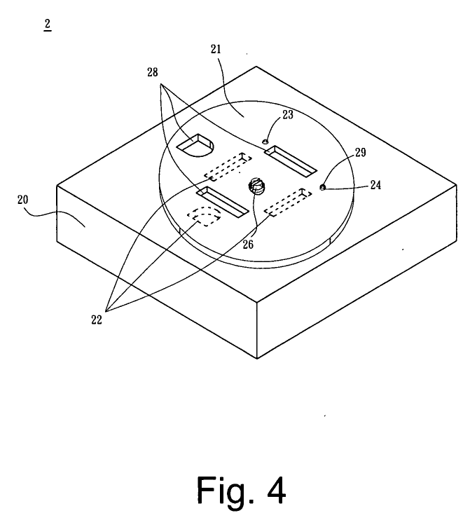

Please refer to FIG. 3, which is a schematic diagram showing the assembly structure of the socket unit and the protecting device in FIG. 2, wherein the electrode holes are in an open status. As shown in FIGS. 2 and 3, when the protecting device 21 is rotated and the third positioning element 29 is engaged with the first positioning element 23 on the socket unit 20, the electrode holes 22 of the socket unit 20 are exposed due to the alignment of the plural openings 28 of the protecting device 21 and the electrode holes 22 of the socket unit 20. Hence the terminals of the plug can be plugged into the electrode holes 22. Please refer to FIG. 4, which is a schematic diagram showing the assembly structure of the socket unit and the protecting device in FIG. 2, wherein the electrode holes are in a closed status. As shown in FIGS. 2 and 4, when the protecting device 21 is rotated so that the third positioning element 29 is departed from the first positioning element 23 and further engaged with the second positioning element 24 on the socket unit 20, the electrode holes 22 are covered due to the stagger of the plural openings 28 of the protecting device 21 and the electrode holes 22 of the socket unit 20, so as to prevent the dust or the foreign matters from getting into the electrode holes 28 of the socket unit 20.

Please refer to FIG. 2 again. In some embodiments, the rotating portion 26 of the protecting device 21 comprises a rotating shaft 261 and a protrusion 262 disposed on the bottom end of the rotating shaft 261 and having a diameter larger than that of the rotating shaft 261. The rotating portion 26 can be made of a flexible material and further comprises a slit 263 for dividing the rotating shaft 261 and the protrusion 262 into two parts, respectively, so as to facilitate the assembling of the protecting device 21 and the socket unit 20. The rotating portion 26 is fixed in the pivot hole 25 with the protrusion 262 while the rotating portion 26 is inserted into the pivot hole 25, so as to prevent the protecting device 21 from departing from the socket unit 20. In some embodiments, the rotating portion 26 of the protecting device 21 may also be a bolt for piercing through the pivot hole 25 of the socket unit 20 to fix the protecting device 21 on the socket unit 20.

In some other embodiments, plural socket units 20 with protecting devices 21 as described above are combined together to make a socket set. The protecting device 21 can be designed with different shapes, such as round, square, or ellipse, in response to different appearances of the socket products, and the color of the protecting device 21 can also be varied for distinguishing or pleasing.

To sum up, a socket with a protecting device is provided in this invention. Via the rotation of the protecting device, the electrode holes of the socket unit can be closed when the plural openings of the protecting device and the electrode holes of the socket unit are staggered. Therefore the dust or other foreign matters, such as water, other liquid or solid subjects, are prevented from getting into the electrode holes, so as to avoid the bad electric contact or short circuit. Moreover, kids will not touch the interior of the electrode holes easily and get electric shocks while the electrode holes are closed. On the other hands, the structure of the socket with the protecting device according to the present invention is simpler than the conventional socket with the protecting device. For this reason, the cost of the production and fabrication is reduced and the yield can be raised up. Further, the socket with the protecting device in the present invention deals with the problem of the prior art that wasting space for the movement of the protecting device.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A socket with a protecting device, comprising:
a socket unit having a surface with plural electrode holes and a pivot hole thereon; and
a protecting device disposed on said surface of said socket unit for protecting said plural electrode holes of said socket unit, said protecting device comprising:
plural openings corresponding to said plural electrode holes of said socket unit; and
a rotating portion to be plugged into said pivot hole of said socket unit;
thereby said protecting device rotates relatively to said surface of said socket unit for aligning or staggering said plural openings and said plural electrode holes to render said socket in an open or a closed status.

2. The socket with a protecting device according to claim 1 wherein said socket unit further comprises a first positioning element and a second positioning element disposed thereon, and said protecting device further comprises a third positioning element to be engaged with said first positioning element or said second positioning element.

3. The socket with a protecting device according to claim 2 wherein when said third positioning element is engaged with said first positioning element, said plural openings and said plural electrode holes are aligned to render said socket in said opening status.

4. The socket with a protecting device according to claim 2 wherein when said third positioning element is engaged with said second positioning element, said plural openings and said plural electrode holes are staggered to render said socket in said closed status.

5. The socket with a protecting device according to claim 2 wherein said first positioning element and said second positioning element are positioning blocks while said third positioning element is a positioning hole.

6. The socket with a protecting device according to claim 2 wherein said first positioning element and said second positioning element are positioning holes while said third positioning element is a positioning block.

7. The socket with a protecting device according to claim 1 wherein said rotating portion comprises:
a rotating shaft;
a protrusion disposed on the end of said rotating shaft; and
a slit for dividing said rotating shaft and said protrusion into two parts, respectively.

8. A protecting device disposed on a socket, said socket including at least a socket unit having a surface with plural electrode holes and a pivot hole thereon, said protecting device comprising:
plural openings corresponding to said plural electrode holes of said socket unit; and
a rotating portion to be plugged into said pivot hole of said socket unit;
thereby said protecting device rotates relatively to said surface of said socket unit for aligning or staggering said plural openings and said plural electrode holes to render said socket in an open or a closed status.

9. The protecting device according to claim 8 wherein said socket unit further comprises a first positioning element and a second positioning element disposed thereon, and said protecting device further comprises a third positioning element to be engaged with said first positioning element or said second positioning element.

10. The protecting device according to claim 9 wherein when said third positioning element is engaged with said first positioning element, said plural openings and said plural electrode holes are aligned to render said socket in said opening status.

11. The protecting device according to claim 9 wherein when said third positioning element is engaged with said second positioning element, said plural openings and said plural electrode holes are staggered to render said socket in said closed status.

12. The protecting device according to claim 9 wherein said first positioning element and said second positioning element are positioning blocks while said third positioning element is a positioning hole.

13. The protecting device according to claim 9 wherein said first positioning element and said second positioning element are positioning holes while said third positioning element is a positioning block.

14. The protecting device according to claim 8 wherein said rotating portion comprises:
a rotating shaft;
a protrusion disposed on the end of said rotating shaft; and
a slit for dividing said rotating shaft and said protrusion into two parts, respectively.
